(19) United States
(12) Patent Application Publication
(10) Pub. No.: US 2009/0074376 A1
(43) Pub. Date: Mar. 19, 2009

(54) APPARATUS AND METHOD FOR EFFICIENT AV SYNCHRONIZATION

(75) Inventors: Po-Ting Lin, Tainan County (TW); Shih-Ta Hsu, Tainan County (TW)

Correspondence Address: J C PATENTS, INC., 4 VENTURE, SUITE 250, IRVINE, CA, 92618, US

(73) Assignee: HIMAX TECHNOLOGIES LIMITED, Tainan County (TW)

(21) Appl. No.: 11/856,477

(22) Filed: Sep. 17, 2007

(51) Int. Cl. H04N 5/91

(52) U.S. Cl. 386/66; 386/E05.001

(57) ABSTRACT

An apparatus and a method for an efficient audio/video (AV) synchronization are provided. The apparatus includes a parser, a frame memory, a video start code (VSC) detector and a video decoder. The parser is used for analyzing a packetized elementary stream (PES) and outputting a video stream, an address information and at least one time stamp, in which the video stream includes a frame and at least one VSC corresponding to the frame. The frame memory is used for temporarily storing the video stream according to the address information. The VSC detector is used for retrieving the VSC of the video stream. The video decoder is used for selecting the frame from the frame memory according to the VSC and the address information provided by the VSC detector.

### BACKGROUND OF THE INVENTION

1. Field of the Invention

The present invention relates to audio/video (AV) synchronization. More particularly, the present invention relates to an apparatus and a method for AV synchronization.

2. Description of Related Art

As the progress of computer science and technology and network information, modern people have increasingly high requirements for the definition of image, and accordingly, digital image technologies, for example, high definition television (HDTV), digital versatile disc (DVD), and videoconference are generated. All these technologies need to process a large amount of patterns and images, and Motion Picture Experts Group-2 (MPEG-2) is a compression and transmission standard for solving the problems. The compressed video, audio, and other data are inserted into a MPEG-2 transport stream packet with a fixed length for transmission.

In addition, the compressed video and audio cannot be played normally unless they are processed. However, when they are processed, a playing time difference possibly occurs between the video and the audio. In order to eliminate the playing time difference between the video and the audio, it is necessary to regularly check whether the video and the audio are synchronized, and to appropriately adjust the playing time of the video and the audio.

FIG. 1 is a block diagram of a conventional apparatus for AV synchronization. Referring to FIG. 1, an apparatus for AV synchronization 100 includes a parser 110, a double data rate (referred as DDR hereafter) memory 120 and a video decoder 130. The parser 100 receives and analyzes a packetized elementary stream (PES). After a presentation time stamp (referred as PTS hereafter) or a decoding time stamp (referred as DTS hereafter) stored at a PES header is analyzed, it is transmitted to the video decoder 130 for being decoded, so as to obtain an AV data before compression. A video frame analyzed from the PES is transmitted to the DDR memory 120 and temporarily stored therein. If the video decoder 130 needs to use the video frame during the decoding process, it can search the video frame from the DDR memory 120.

However, during the decoding process of the video decoder 130, if no signal is received or the video and the audio are not synchronized during a time period, it is necessary to skip some video frames or to repeat certain video frames, so as to re-synchronize the audio and the video. At this time, the video decoder 130 must find a correct video frame from the DDR memory 120, so as to solve the AV asynchronization problem. Since the exact address where the correct video frame is stored in the DDR memory 120 cannot be figured out, it is necessary to search from the very beginning until the correct video frame is found. In this manner, too much searching time is required and bandwidth of a memory is wasted.

### SUMMARY OF THE INVENTION

Accordingly, the present invention is directed to an apparatus and a method for AV synchronization, capable of reducing an adjusting time of the AV synchronization and saving bandwidth of the memory.

As embodied and broadly described herein, the present invention provides an apparatus for AV synchronization. The apparatus includes a parser, a frame memory, a video starting code (VSC) detector, and a video decoder. The parser is used to analyze a PES and to output a video stream, an address information, and at least one time stamp, in which the video stream includes a frame and at least one VSC corresponding to the frame. The frame memory is used to temporarily store the video stream according to the address information. The VSC detector is used to retrieve the VSC of the video stream. The video decoder is used to select the frame from the frame memory according to the VSC and the address information provided by the VSC detector.

The present invention provides a method for AV synchronization, which includes: analyzing the PES to obtain a video stream and at least one time stamp, in which the video stream includes a frame and at least one VSC corresponding to the frame; determining an address information to temporarily store the video stream to a frame memory; utilizing a VSC detector to retrieve the VSC of the video stream; and selecting the frame from the frame memory according to the VSC and the address information provided by the VSC detector.

In the present invention, the VSC detector is used to detect and store the VSC and the address information, so as to reduce the time for searching the data in the frame memory. When the AV asynchronization occurs, according to the information provided by the VSC detector, the VSC can directly take out the correct frame from the memory to perform the AV synchronization adjustment without searching the frames one by one. Therefore, the present invention can effectively reduce the adjusting time of the AV synchronization.

In order to make the aforementioned and other objects, features and advantages of the present invention comprehensible, embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of a conventional apparatus for AV synchronization.

FIG. 2 is a block diagram of an apparatus for AV synchronization according to an embodiment of the present invention.

FIG. 3 is a flow chart of a method for AV synchronization according to an embodiment of the present invention.

FIG. 4 is a block diagram of an apparatus for AV synchronization according to another embodiment of the present invention.

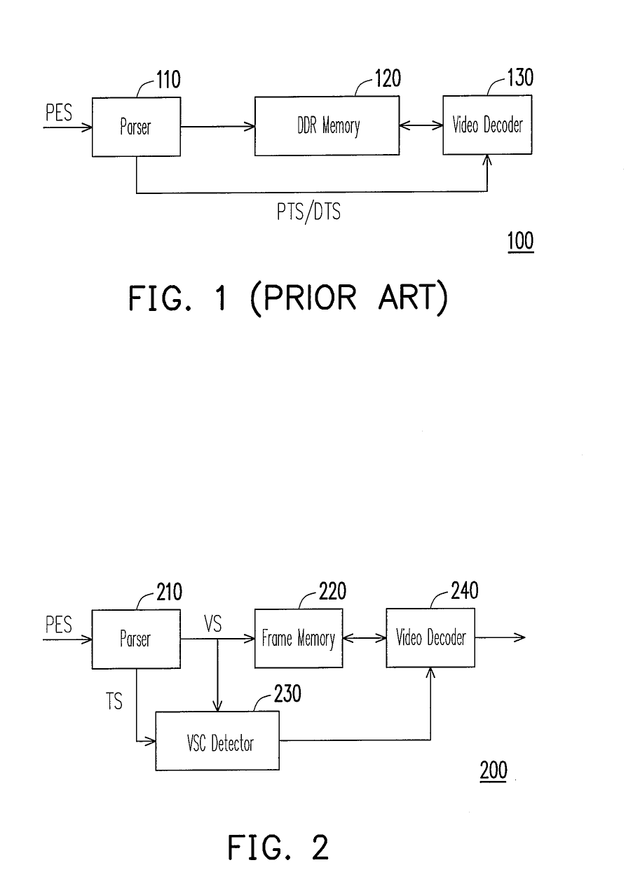

### DESCRIPTION OF EMBODIMENTS

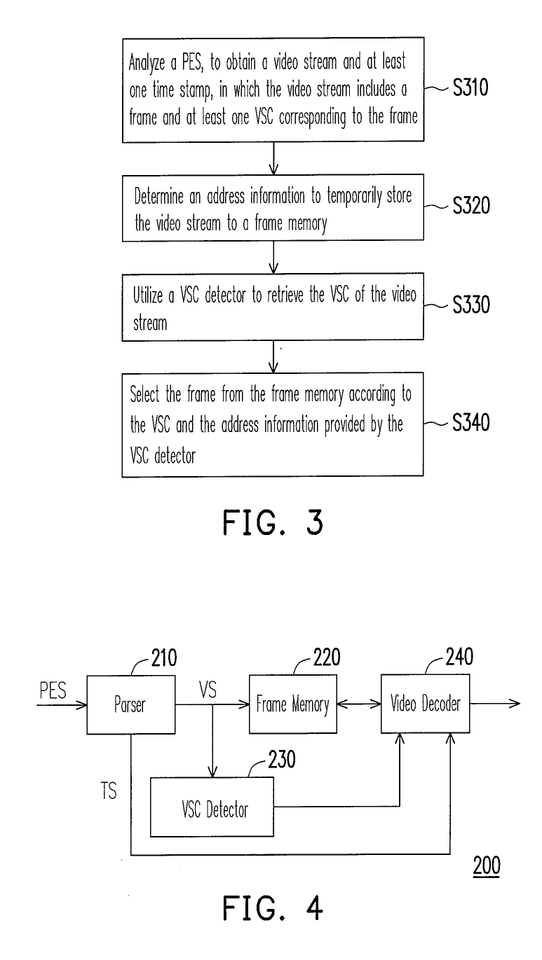

FIG. 2 is a block diagram of an apparatus for AV synchronization according to an embodiment of the present invention, and FIG. 3 is a flow chart of a method for AV synchronization according to an embodiment of the present invention. First, referring to FIG. 2, the apparatus for AV synchronization 200 includes a parser 210, a frame memory 220, a VSC detector 230 and a video decoder 240. Referring to FIGS. 2 and 3, the operation flow of this embodiment is described as follows.

In Step S310, first, a PES is provided to the parser 210, in which the PES is formed by a plurality of packets. Each PES packet includes a packet header and a packet payload. The PES packet is generated by dividing the elementary stream into a preset bit length. The elementary stream includes successive video or audio data bits compressed according to the MPEG-2 standard.

After the PES is analyzed by the parser 210, a video stream VS and a time stamp TS are obtained, and the time stamp TS can be, for example, a PTS or a DTS. The PTS indicates when the video will be played, and DTS indicates when the video will be decoded. The video stream VS includes a frame and a VSC corresponding to the frame. The VSC is, for example, a picture start code, a sequence header code, a sequence end code, or a group start code.

Next, in Step S320, the video stream VS is output to the frame memory 220 and the VSC detector 230, and the time stamp TS is output to the VSC detector 230. Before the video stream VS is output to the frame memory 220 and the VSC detector 230, the parser 210 firstly determines an address information. The address information is an address for the VSC to be temporarily stored on the frame 220. Therefore, when the video stream VS is output to the frame memory 220, the frame memory 220 stores the VSC and the frame on the corresponding address according to the address information. For example, when the address information is 100, the video stream VS is directly stored on the address 100 in the frame memory 220. In this embodiment, the frame memory 220 is, for example, a DDR memory.

In Step S330, after the VSC detector 230 receives the video stream VS, it retrieves the VSC in the video stream VS, and stores the VSC together with the address information provided by the parser 210. As for the storage of the results, for example, a look-up table is established in the VSC detector 230, so as to store the corresponding relation between the VSC and the address information. For example, in the look-up table, it is recorded that a VSC “0001” corresponds to the address information “50”, which indicates that the VSC “0001” is stored on the address “50” in the frame memory. Furthermore, if it is recorded in the look-up table that a VSC “0002” corresponds to the address information “60”, it indicates that the VSC “0002” is stored on the address “60” in the frame memory. In this manner, it is helpful for the subsequent procedure to quickly look up the address where the video stream VS is temporally stored. The VSC detector 230 outputs the time stamp TS to the video decoder 240, so as to perform the video decoding operation.

In Step S340, if the video decoder 240 finds that the video and the audio are asynchronous (that is, the video leads or lags behind), it is necessary to perform an action of skipping or repeating the frame, so as to make the video and the audio return to the synchronization state. Therefore, the video decoder 240 needs to search the correct frame, and the VSC corresponding to the frame is, for example, “0001”. At this time, the video decoder 240 can look up the address where the correct frame is stored in the frame memory 220 according to the VSC and the address information stored in the VSC detector 230. Therefore, it can be found from the look-up table of the VSC detector 230 that the VSC “0001” is, for example, stored on the address “50” in the frame memory 220. Through the above searching result, the correct frame can be selected on the address “50” in the frame memory 220, so as to perform the AV synchronization adjustment. Therefore, when the video decoder 240 of this embodiment searches the correct frame from the frame memory 220, it need not search the frames one by one, so as to reduce the searching time and to save the bandwidth of the memory.

In addition, in the above embodiment, the VSC detector 230 stores the detected VSC and the address information together. However, alternatively, the VSC detector 230 may not perform the storing action, but output the retrieved VSC and the address information to the video decoder 240, such that the video decoder 240 stores them by itself.

FIG. 4 is a block diagram of an apparatus for AV synchronization according to another embodiment of the present invention. Referring to FIGS. 2 and 4, the difference between FIGS. 4 and 2 lies in that, the time stamp TS of FIG. 2 is output to the video decoder 240 through the VSC detector 230, so as to perform the video decoding action, and the time stamp TS of FIG. 4 is directly output to the video decoder 240 by the parser 210, so as to perform the video decoding action. In this embodiment, the changes in outputting the time stamp TS does not affect the spirit of the present invention, and the functions of the elements and the operation flow are the same as that of the previous embodiment, so it is not repeatedly described herein.

To sum up, in the present invention, the VSC detector is used to detect and store the VSC of the video stream and the address information, so as to reduce the searching time in the frame memory, and to quickly find out the address where the VSC is temporarily stored in the frame memory. When the AV asynchronization occurs, according to the information provided by the VSC detector, the VSC decoder can directly find out the correct frame from the memory to perform the AV synchronization adjustment, without searching the frames one by one. Therefore, the present invention can effectively reduce the adjusting time of the AV synchronization and can save the bandwidth of the memory.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An apparatus for audio/video (AV) synchronization, comprising:
a parser, for analyzing a packetized elementary stream (PES), and outputting a video stream, an address information, and at least one time stamp, wherein the video stream comprises a frame and at least one video start code (VSC) corresponding to the frame;
a frame memory, for temporarily storing the video stream according to the address information;
a VSC detector, for retrieving the VSC of the video stream; and
a video decoder, for selecting the frame from the frame memory according to the VSC and the address information provided by the VSC detector.

2. The apparatus for AV synchronization as claimed in claim 1, wherein the address information and the VSC are stored in the VSC detector.

3. The apparatus for AV synchronization as claimed in claim 1, wherein the address information is an address for the VSC to be temporarily stored on the frame memory.

4. The apparatus for AV synchronization as claimed in claim 1, wherein the time stamp comprises a presentation time stamp (PTS) or a decoding time stamp (DTS).

5. The apparatus for AV synchronization as claimed in claim 1, wherein the VSC comprises a picture start code, a sequence header code, a sequence end code, or a group start code.

6. The apparatus for AV synchronization as claimed in claim 1, wherein the frame memory is a double date rate (DDR) memory.

7. A method for AV synchronization, comprising:
analyzing a PES to obtain a video stream and at least one time stamp, wherein the video stream comprises a frame and at least one VSC corresponding to the frame;
determining an address information to temporarily store the video stream to a frame memory;
utilizing a VSC detector to retrieve the VSC of the video stream; and
selecting the frame from the frame memory according to the VSC and the address information provided by the VSC detector.

8. The method for AV synchronization as claimed in claim 7, wherein the VSC and the address information are stored in the VSC detector.

9. The method for AV synchronization as claimed in claim 7, wherein the address information is an address for the VSC to be temporarily stored on the frame memory.

10. The method for AV synchronization as claimed in claim 7, wherein the time stamp comprises a PTS or a DTS.

11. The method for AV synchronization as claimed in claim 7, wherein the VSC comprises a picture start code, a sequence header code, a sequence end code, or a group start code.
